(19) United States
(12) Patent Application Publication
(10) Pub. No.: US 2022/0026209 A1
(43) Pub. Date: Jan. 27, 2022

(54) LINEAR ACCELERATION SENSOR AND OPERATING METHOD FOR THE SAME

(71) Applicant: HONEYWLD TECHNOLOGY CORP., Hsinchu City (TW)

(72) Inventor: JEN-CHIEN HSU, HSINCHU CITY (TW)

(21) Appl. No.: 16/936,873

(22) Filed: Jul. 23, 2020

(51) Int. Cl. G01C 19/00; G01P 13/00; G01P 15/18

(52) U.S. Cl. CPC G01C 19/00; G01P 15/18; G01P 13/00

(57) ABSTRACT

A linear acceleration sensor and an operating method for the same are provided. The sensor elements installed in the linear acceleration sensor include an accelerometer and a gyroscope. The accelerometer is used to measure acceleration values along axes of the linear acceleration sensor over a period of time. The gyroscope is used to measure angular velocities of the sensor over the period of time. In the operating method, the measurement data from the accelerometer and the gyroscope are transformed to a reference frame through a mapping process. A filtering process is performed on the mapped data in order to separate a gravity value from the data. Therefore, the motion signals with respect to the linear acceleration sensor can be obtained.

### FIELD OF THE DISCLOSURE

The present disclosure is generally related to an acceleration sensor, and more particularly to a linear acceleration sensor that is able to obtain motion signals through a mapping process and a filtering process and an operating method for the same.

### BACKGROUND OF THE DISCLOSURE

An accelerometer is generally used to measure a movement of an object. If any object is connected to the accelerometer, an acceleration of the object can be measured. For example, if a person wears an accelerometer, the accelerometer can be used to measure the acceleration of this person.

However, the acceleration read from the accelerometer simultaneously includes a motion component and a gravity component. Therefore, the gravity component should be separated and ignored for measuring the actual movement of the object that is connected with the accelerometer. For example, in order to determine an orientation of the object at an azimuth angle, the gravity component of the acceleration should be separated.

In general, if the object with the accelerometer is fixed toward a certain orientation, a specific filtering process such as a low-pass filtering process can be used to separate the motion component and the gravity component. FIG. 1 shows a flow chart describing a process to obtain motion signals of an object from an accelerometer. In step S101, the accelerometer is used to measure accelerations at the directions along X, Y and Z axes. In step S103, a low-pass filter is used to filter out the gravity values along the axes. The gravity values along the X, Y and Z axes can therefore be calculated. The gravity values along the different axes are constants if the object remains in a fixed orientation. It should be noted that the gravity is constant in nature, and therefore the low-pass filter can be used to separate the motion signals from the constants. The motion signals can be obtained from the acceleration values, such as in step S105.

In another case, if the object is rotating, the gravity values along the axes measured by the accelerometer are changed. The conventional low-pass filter fails to separate the motion signals from the changed gravity values of the measured acceleration.

### SUMMARY OF THE DISCLOSURE

In response to the above-referenced technical inadequacies, the present disclosure provides a linear acceleration sensor and an operating method for the same.

For solving the issue with the conventional technology, that motion signals can be obtained from the acceleration by a low-pass filter only if an object remains in a fixed orientation, the present disclosure provides a linear acceleration sensor and an operating method for the same. In the method, a plurality of measurement values responsive to statuses of the linear acceleration sensor are continuously measured, and the measurement values are stored to a memory. The measurement values are then transformed to a same reference frame from their original coordinate system through a mapping process. A filtering process is performed to separate a gravity value from the mapped measurement values. The motion signals of the linear acceleration sensor can then be obtained from the measurement values.

The linear acceleration sensor includes an accelerometer that is used to measure axial acceleration values of the linear acceleration sensor for a continuous period of time, and a gyroscope that is also used to measure angular velocities of the linear acceleration sensor. The measurement values such as the acceleration values and the angular velocities are temporarily stored to a memory.

In one aspect of the disclosure, the gravity value is low-frequency signals that can be filtered out by a low-pass filter in a filtering process so as to separate the gravity value.

According to one of the embodiments of the linear acceleration sensor, the main components of the linear acceleration sensor include a micro-controller, an accelerometer and a gyroscope. The accelerometer and the gyroscope measure multiple accelerations along axes and angular velocities of the linear acceleration sensor for a continuous period of time. The method performed by the micro-controller transforms the multiple acceleration values and the angular velocities to a same reference frame through a mapping process. A filtering process is used to filter out a gravity value from the mapped acceleration values and the angular velocities so as to obtain the motion signals of the sensor by eliminating the gravity value.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 shows a flow chart describing a conventional process to obtain motion signals from an accelerometer;

FIG. 2 is a schematic diagram depicting a circuit system of a linear acceleration sensor according to one embodiment of the disclosure;

FIG. 3 is a schematic diagram depicting an electronic device with a linear acceleration sensor in one embodiment of the disclosure;

FIG. 4 shows a flow chart describing an operating method of the linear acceleration sensor according to one embodiment of the disclosure;

FIG. 5 shows another flow chart describing the operating method in one embodiment of the disclosure;

FIG. 6 is a schematic diagram depicting coordinate transformation in the operating method in one embodiment of the disclosure;

FIG. 7 is another schematic diagram depicting coordinate transformation in another embodiment of the disclosure;

FIG. 8 shows one further diagram depicting coordinate transformation in one embodiment of the disclosure; and

FIG. 9 shows a schematic diagram depicting coordinate transformation in the operating system in one embodiment of the disclosure.

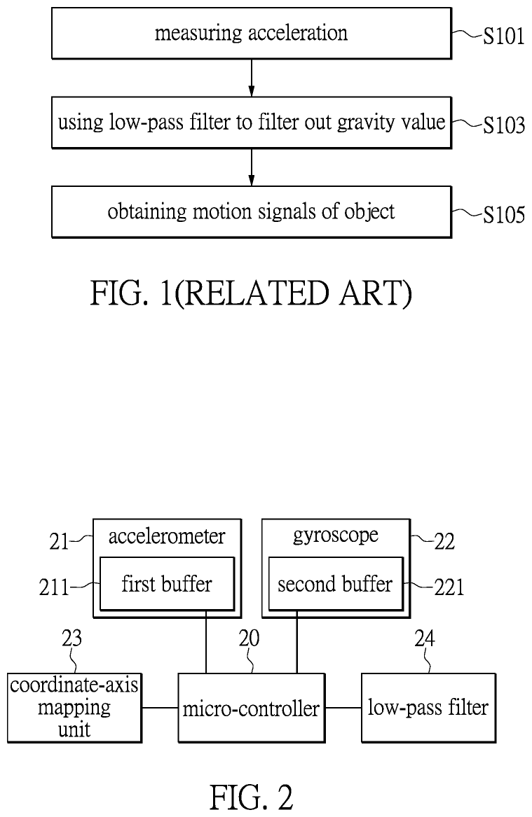

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

For solving the limitation of conventional technology that only under a specific circumstance the gravity data can be separated from signals generated by an accelerometer for obtaining motion signals, provided in the disclosure is a linear acceleration sensor and an operating method thereof. The linear acceleration sensor includes an accelerometer and a gyroscope in general.

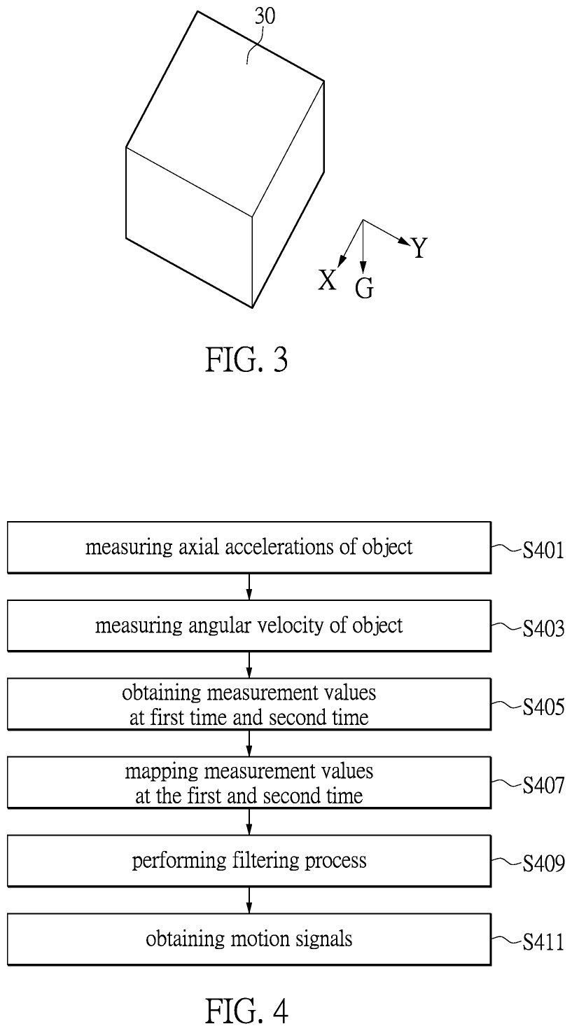

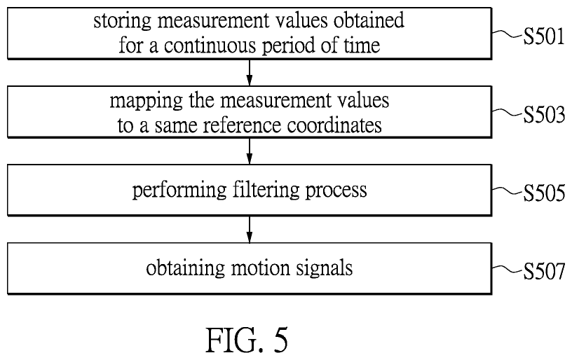

Reference is made to FIG. 2, which is a schematic diagram depicting a circuit system of a linear acceleration sensor in one embodiment of the disclosure. A micro-controller 20 is provided as an operating core of the linear acceleration sensor for processing signals generated by circuit components of the sensor. A final result can be calculated according to the signals generated by these circuit components. For example, the result is such as motion signals of an object associated with the linear acceleration sensor. The linear acceleration sensor can be used inside an electronic device 30 shown in FIG. 3. The electronic device 30, such as the mentioned object, is in a coordinate system that can be expressed by the values including X, Y, and G when it is static. The value ‘G’ indicates the direction of gravity. The sensor and the related components can be referred to the schematic diagram of FIG. 2. The status of electronic device 30 changes with time and the linear acceleration sensor continuously measures the sensing values. The operating method performed in the linear acceleration sensor can be referred to in the exemplary processes described in FIG. 4 or FIG. 5.

The linear acceleration sensor includes a micro-controller 20, and some other hardware elements and electronic components connected to the micro-controller 20. The components are such as an accelerometer 21 and a gyroscope 22. Since the sensor elements in the linear acceleration sensor may generate measurement data intensively in a short period of time, the accelerometer 21 and the gyroscope 22 may have their own buffer memories for buffering the measurement data for maintaining the operational efficiency. In an exemplary example shown in the diagram, a first buffer 211 and a second buffer 221 are used to serve the accelerometer 21 and the gyroscope 22 for buffering the measurement data respectively. Alternatively, the buffers can also use a common shared memory, and the aforementioned first buffer 211 and second buffer 221 can be two logical memory blocks in one memory. Then the linear acceleration sensor stores the measurement data in the buffers. The data stored in the buffers can be kept for a period of time according to a setting. The oldest data will be deleted when new data is generated. According to the setting, the micro-controller 20 can retrieve the latest data from the buffers.

A coordinate-axis mapping unit 23 is a software-implemented or a circuit based component in the linear acceleration sensor. In one embodiment of the disclosure, the functions of the coordinate-axis mapping unit 23 can be implemented by a firmware in the micro-controller 20. One of the objectives of the coordinate-axis mapping unit 23 is to transform the measurement data generated in different times to a same coordinate system for further comparison and determination. The data at the previous time and the later time can therefore be compared and determined based on the same reference.

A low-pass filter 24 is also a software-implemented or a circuit based component of the linear acceleration sensor. When the micro-controller 20 receives the measurement data being processed by the coordinate-axis mapping unit 23, the low-pass filter 24 is used to separate the specific signals from the measurement value in a filtering process.

The accelerometer 21 is used to measure acceleration values with respect to the linear acceleration sensor continuously along axes of the coordinate system, e.g., X axis, Y axis and Z axis. The measured acceleration values include a plurality of axial acceleration components. The measurement values are firstly buffered in the first buffer 211 (step S401). The gyroscope 22 measures statuses of the linear acceleration sensor for a continuous period of time according to principle of conservation of angular momentum. The statuses are such as angular velocities measured for a continuous period of time. Similarly, the measurement values are buffered in the second buffer 221 (step S403). In one of the embodiments, measurement value generated by the sensor element reflects a status of an object associated with the linear acceleration sensor. The status can denote a movement or an orientation of the object such as an electronic device 30 of FIG. 3 at each period of time.

It should be noted that there is no absolute order of the abovementioned step S401 and step S403 of FIG. 4 under a normal operation. The plurality of acceleration values and angular velocities form a plurality of measurement data. Both the first buffer 211 and the second buffer 221 store the measurement data for a period of time, e.g., several seconds. An amount of the measurement data is limited to capacities of the buffers.

The coordinate-axis mapping unit 23 of the linear acceleration sensor retrieves the acceleration values and the angular velocities respectively buffered in the first buffer 211 and the second buffer 221 via the micro-controller 20. The acceleration value and the angular velocity at a first time form a first measurement value (step S405). The first measurement value can be the latest measurement data being measured currently. The acceleration value and the angular velocity at a second time form a second measurement value that can be the data measured at the previous time. After that, the measurement data being measured at the first time and the second time are mapped (step S407). The mapping method can be coordinate transformation that transforms the plurality of acceleration values and the angular velocities to the same reference frame.

For example, the acceleration value and the angular velocity previously measured in a previous coordinate system at the second time are mapped to a current coordinate system as the acceleration value and the angular velocity that are measured at the first time. The coordinates are changed at different times since the status of object changes over time in a three-dimensional space. The mapping process may be performed continuously. One of the objectives of the mapping process is to map the measurement data at their original coordinate system to the same reference frame for further comparison. A filtering process is then performed on the measurement data after the mapping process. The gravity value is low-frequency signals that can be processed by a low-pass filter. The gravity value can be separated from the acceleration value and the angular velocity when the measurement data is mapped to the same reference frame (step S409).

The object is such as a hand-held electronic device with the linear acceleration sensor. More specifically, when the object rotates, the axial acceleration values and the angular velocities to be measured with respect to the object change over time since both the orientation and coordinate axes of the object are changed. It should be noted that the acceleration values and the angular velocities with respect to the rotation angles of the object are measured at sampling times, and in the meantime the coordinate-axis mapping unit 23 of the linear acceleration sensor can map the measurement data measured over different coordinate axes at different times onto a same reference frame. In an actual operation, the past measurement data is mapped to a present reference frame. Thus, the required values can be separated through a filtering process once the measurement data at the different times are mapped to the same reference frame. For example, the gravity can be regarded as a fixed value and a low-pass filter can be used to filter out the gravity value so as to obtain the motion signals from the acceleration values and the angular velocities measured by the linear acceleration sensor. The motion signals represent the movement of the linear acceleration sensor (step S411).

In one embodiment of the disclosure, a pure acceleration data can be obtained after separating the gravity value. A mathematic calculation is used to obtain the continuous positions of the object so as to render a moving track over time. Therefore, in an electronic device with the linear acceleration sensor, the above-mentioned scheme is able to separate the gravity value from the measurement data generated by the linear acceleration sensor so as to obtain the motion signals of the electronic device in a three-dimensional space. Then, a gesture performed by a user who is manipulating the electronic device can be sensed.

FIG. 5 next shows a flow chart describing an operating method of the linear acceleration sensor according to one embodiment of the disclosure. In the process shown in FIG. 5, the linear acceleration sensor continuously measures statuses of the sensor by its one or more sensor elements. The one or more sensor elements continuously measure a plurality of measurement values that can be temporarily stored into a memory of the linear acceleration sensor. The one or more sensor elements generally refers to, but is not limited to, the aforementioned accelerometer and/or gyroscope. Both the accelerometer and the gyroscope continuously measure the acceleration values and the angular velocities.

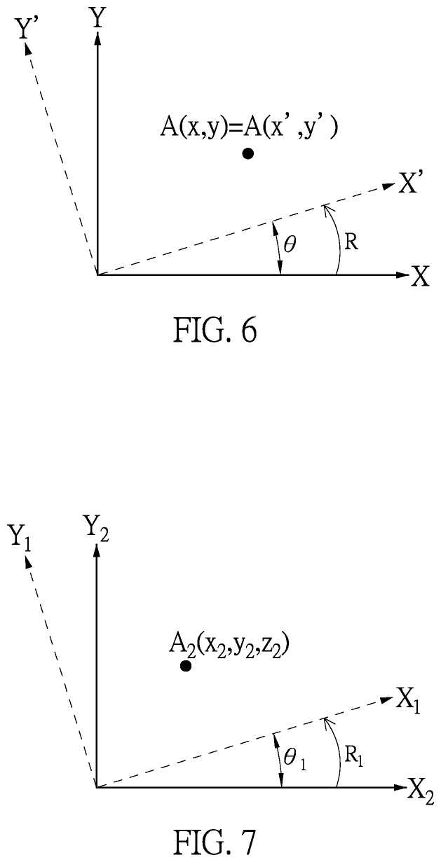

In the present embodiment, in step S501, the measurement data with respect to the statuses of the linear acceleration sensor is stored into the memory therein. The measurement data is such as the measurement values generated by the accelerometer and the gyroscope. The memory can be a buffer in the electronic components or a storage medium in the device that includes the linear acceleration sensor. The linear acceleration sensor relies on the capacity of the memory to adjust the amount of data to be stored. The measurement values are stored at sampling times according to the capacity of memory and requirements, and can be represented by 1^{st} measurement value to n^{th} measurement value. More particularly, the coordinate system of the object, e.g., the electronic device, associated to the linear acceleration sensor changes at different sampling times because the status of the object changes over time. A mapping process, such as in step S503, is used to map the measurement values at the different sampling times to the same reference frame. The exemplary examples are as shown in FIG. 6 to FIG. 9.

Still further, in the step S503, the measurement values are retrieved from the memory, and the measurement values are mapped to the same reference frame. The gravity values involved in the measurement values become a constant since the measurement values are mapped to the same reference frame. This constant gravity value can be separated from the measurement values. In step S505, a filtering process is performed to filter out the gravity value from the measurement values. A low-pass filter can be used to separate the gravity value since the gravity value is a kind of low-frequency signal. In step S507, the motion signals with respect to the linear acceleration sensor can be obtained from the measurement values, in which the measurement values that are obtained at different sampling times form the motion signals for a continuous period of time in a reference frame.

The following are examples of processes that are operated in the linear acceleration sensor and the processes are generally performed by firmware programs in a micro-controller of the linear acceleration sensor. It should be noted that the values measured by the sensor elements of the linear acceleration sensor are physical quantities with directionalities.

Firstly, the accelerometer of the linear acceleration sensor measures axial accelerations, e.g., along x, y and z axes, at a sampling time. Formula 1 indicates the axial accelerations (aₓ, a_{y} and a_{z}).

$$A = ⌊ \begin{matrix}{a}_{x} \\ {a}_{y} \\ {a}_{z}\end{matrix} ⌋ \qquad ( formula 1 )$$

A buffer of the linear acceleration sensor can be used to store the acceleration values. The buffer is such as the first buffer of the accelerometer depicted in the above-mentioned embodiment exemplarily shown in FIG. 2. Formula 2 indicates an acceleration array that includes acceleration values (A₁, A₂, A₃, . . . and Aₙ) that are stored in the buffer and obtained at 1^{st} time to n^{th} time.

A_{array}=[A₁,A₂,A₃,A₄, . . . ,Aₙ] (formula 2)

Formula 3 indicates the axial angular velocities (ωₓ, ω_{y} and ω_{z}) measured by the gyroscope of the linear acceleration sensor at the sampling times.

$$Ω = ⌊ \begin{matrix}{ω}_{x} \\ {ω}_{y} \\ {ω}_{z}\end{matrix} ⌋ \qquad ( formula 3 )$$

Similarly, the angular velocities obtained at 1^{st} time to n^{th} time are stored into the buffer of the linear acceleration sensor. The buffer is such as the second buffer of the gyroscope depicted in FIG. 2. The angular velocities (Ω₁, Ω₂, . . . and Ωₙ) can be indicated in Formula 4.

Ω_{array}=[Ω₁,Ω₂,Ω₃,Ω₄, . . . ,Ωₙ] (formula 4)

The angular velocities in the array of formula 4 are multiplied by a sampling time Tₛ so as to obtain axial rotation angles at each sampling time. Formula 5 indicates the formula to calculate the axial rotation angles (θₓ, θ_{y} and θₓ).

$$Θ = ⌊ \begin{matrix}{ω}_{x} {T}_{s} \\ {ω}_{y} {T}_{s} \\ {ω}_{z} {T}_{s}\end{matrix} ⌋ = ⌊ \begin{matrix}{θ}_{x} \\ {θ}_{y} \\ {θ}_{z}\end{matrix} ⌋ \qquad ( formula 5 )$$

Next, another array shown in formula 6 is used depict the rotation angles of the object during continuous sampling times (1^{st} time to n^{th} time) that indicate changes of the rotation angles for a continuous period of time.

Θ_{array}=[Θ₁,Θ₂,Θ₃,Θ₄ . . . ,Θₙ] (formula 6)

After that, a mapping process is performed. Formula 7 depicts an example of a transformation array of a two-dimensional coordinate system. The coordinate system of the gyroscope changes with the changes of the status of the object associated with the linear acceleration sensor. If the coordinate system of the gyroscope rotates, the mapping process is performed to map the axial measurement data, e.g., the angular velocities and the angles, onto a reference frame. FIG. 6 shows a schematic diagram depicting the coordinate transformation. The coordinate axes between two times has an included angle that indicates a change of angle (θ). A transformation matrix R([cos θ, sin θ, −sin θ, cos θ]) is used to transform value A(x, y) in coordinates (X, Y) into a new value A(x′, y′) in coordinates (X′, Y′). Formula 7 indicates a rotation matrix R.

$$R ( θ ) = [ \begin{matrix}cos θ & sin θ \\ - sin θ & cos θ\end{matrix} ] \qquad ( formula 7 )$$

Formula 8 indicates a transformation formula utilizing the rotation matrix R.

$$[ \begin{matrix}{x}^{′} \\ {y}^{′}\end{matrix} ] = [ \begin{matrix}cos θ & sin θ \\ - sin θ & cos θ\end{matrix} ] [ \begin{matrix}x \\ y\end{matrix} ] \qquad ( formula 8 )$$

With three-dimensional coordinate transformation as an example, the rotation matrix can be expressed as the axial rotation matrices (Rₓ, R_{y}, R_{z}), such as those shown in formula 9, formula 10 and formula 11.

$$\begin{matrix}{R}_{x} ( {θ}_{x} ) = [ \begin{matrix}1 & 0 & 0 \\ 0 & cos {θ}_{x} & sin {θ}_{x} \\ 0 & - sin {θ}_{x} & cos {θ}_{x}\end{matrix} ] & ( formula 9 ) \\ {R}_{y} ( {θ}_{y} ) = [ \begin{matrix}cos {θ}_{y} & 0 & - sin {θ}_{y} \\ 0 & 1 & 0 \\ sin {θ}_{y} & 0 & cos {θ}_{y}\end{matrix} ] & ( formula 10 ) \\ {R}_{z} ( {θ}_{z} ) = [ \begin{matrix}cos {θ}_{z} & sin {θ}_{z} & 0 \\ - sin {θ}_{z} & cos {θ}_{z} & 0 \\ 0 & 0 & 1\end{matrix} ] & ( formula 11 )\end{matrix}$$

Formula 12 indicates a three-dimensional transformation matrix R that assembles the axial rotation matrices (Rₓ, R_{y}, R_{z}).

$$R = {R}_{z} ( {θ}_{z} ) {R}_{x} ( {θ}_{x} ) {R}_{y} ( {θ}_{y} ) = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] \qquad ( formula 12 )$$

The elements of the transformation matrix R are as formula 13 indicates.

r₁₁=cos θ_{y} cos θ_{z}+sin θₓ sin θ_{y} sin θ_{z}

r₁₂=cos θₓ sin θ_{z}

r₁₃=−sin θ_{y} cos θ_{z}+sin θₓ cos θ_{y} sin θ_{z}

r₂₁=−cos θ_{y} sin θ_{z}+sin θₓ sin θ_{y} COS θ_{z}

r₂₂ COS θₓ COS θ_{z}

r₂₃=sin θ_{y} sin θ_{z}+sin θₓ cos θ_{y} cos θ_{z}

r₃₁=cos θₓ sin θ_{y}

r₃₂=−sin θ_{xz}

r₃₂=cos θₓ cos θ_{y} (formula 13)

[symbol] 6 [symbol] It should be noted that the order of the three transformation matrices in a three-dimensional space constituting the transformation matrix R can be changed, for example RₓR_{y}R_{z}, RₓR_{z}R_{y} or the like. When the object rotates at a small angle, there is no significant difference when the order of the transformation matrices is changed.

[symbol] 7 [symbol] FIG. 7 shows an exemplary example of the coordinate transformation. At a previous time (e.g., a second time), the second measurement values A2(x₂, y₂, z₂) are obtained under a previous coordinate system (X₂, Y₂, Z₂) (e.g., a second coordinate system). At a next time (e.g., a first time), the next measurement values (e.g., a first measurement value A₁) are obtained under coordinate system (X₁, Y₁, Z₁) (e.g., a first coordinate system). The coordinate system with respect to the object changes because the status of the object changes. FIG. 7 exemplarily shows a change of angle (θ₁). In the mapping process, the measurement value A2(x₂, y₂, z₂) obtained at the second time is mapped to the second coordinate system (X₂, Y₂, Z₂) so as to obtain the first coordinate system (X₁, Y₁, Z₁) at the first time. In an aspect of the disclosure, a transformation matrix R₁ is used to transform coordinates of the second measurement value A₂ to the first coordinate system where the first measurement value A₁ is measured. A second measurement value A₂(x₁, y₁, z₁) that is transformed to the first coordinate system is obtained. Therefore, both the measurement values A₁ and A₂ are at the same reference frame, as indicated in formula 14.

$$⌊ \begin{matrix}{x}_{1} \\ {y}_{1} \\ {z}_{1}\end{matrix} ⌋ = {R}_{1} ⌊ \begin{matrix}{x}_{2} \\ {y}_{2} \\ {z}_{2}\end{matrix} ⌋ = {R}_{1} {A}_{2} \qquad ( formula 14 )$$

After that, a filtering process can be performed onto the measurement values at the same reference frame. For example, the gravity value can be separated from the above-mentioned first measurement value A₁ and second measurement value A₂ so as to obtain the motion signals in the linear acceleration sensor. The motion signals may include data of movement and rotation.

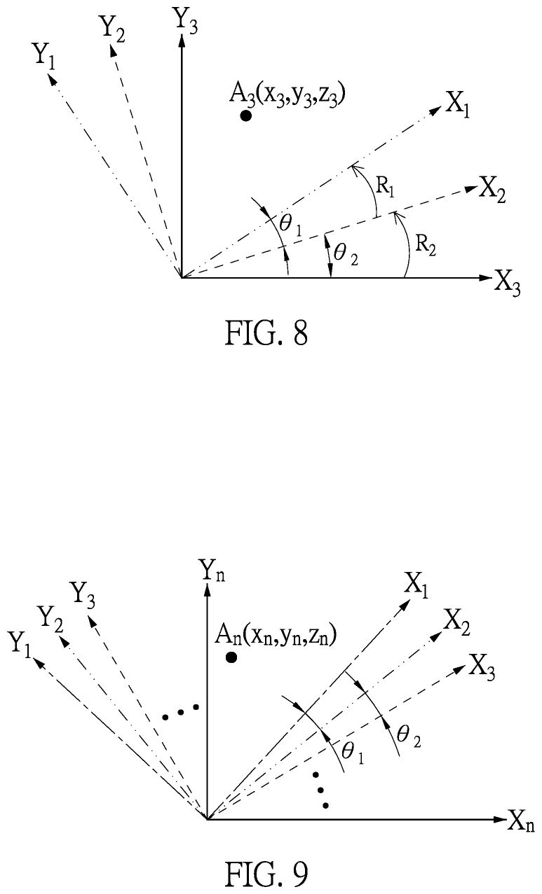

Further, reference is made to FIG. 8 which shows an exemplary example of coordinate transformation. A third measurement value A₃(x₃, y₃, z₃) is measured by the linear acceleration sensor at a third time. The related coordinate system changes with the change of status of an object associated with the linear acceleration sensor. In the diagram, the third measurement value A₃(x₃, y₃, z₃) measured in a third coordinate system (X₃, Y₃, Z₃) forms a change of angle (θ₂) from the second coordinate system (X₂, Y₂, Z₂) at the previous time, e.g., the second time. At a second time, second measurement value A₂ in a second coordinate system (X₂, Y₂, Z₂) is obtained. The second coordinate system (X₂, Y₂, Z₂) at the second time evolves with a change of angle (θ₁) from a first coordinate system (X₁, Y₁, Z₁) where a first measurement value is obtained at a first time.

The changes of statuses of the object result in changes of the coordinates over time. When finally comparing the measurement values, a mapping process should be used to map the measurement values generated at different times onto a same reference frame. In FIG. 8, the third measurement value A₃(x₃, y₃, z₃) is measured in the third coordinate system (X₃, Y₃, Z₃) at the third time. The third coordinate system (X₃, Y₃, Z₃) changes over time and undergoes changes of angles (θ₁, θ₂) from the first coordinate system (X₁, Y₁, Z₁) twice. The mapping process is performed to transform the third coordinate system (X₃, Y₃, Z₃) to the second coordinate system (X₂, Y₂, Z₂) by a transformation matrix R₂, and the third measurement value becomes A₃(x₂, y₂, z₂) in the second coordinate system (X₂, Y₂, Z₂). The mapping process is performed again to transform the third measurement value A₃(x₂, y₂, z₂) that is transformed from the third coordinate system to the first coordinate system (X₁, Y₁, Z₁) via a transformation matrix R₁. The third measurement value A₃(x₂, y₂, z₂) in the second coordinate system is mapped to the reference frame that is the same as the coordinates of the first measurement value A₁. This also means that the third measurement value A₃ measured in the third coordinate system at the third time is transformed to the reference frame being the same as that of the first measurement value A₁ by undergoing matrix transformations (R₁ and R₂) twice, as indicated in formula 15. The third measurement value A₃(x₃, y₃, z₃) is finally transformed as A₃(x₁, y₁, z₁). Thus, the measurement values A₁, A₂ and A₃ are depicted in the same reference frame.

$$⌊ \begin{matrix}{x}_{1} \\ {y}_{1} \\ {z}_{1}\end{matrix} ⌋ = {R}_{1} ⌊ \begin{matrix}{x}_{2} \\ {y}_{2} \\ {z}_{2}\end{matrix} ⌋ = {R}_{1} {R}_{2} ⌊ \begin{matrix}{x}_{3} \\ {y}_{3} \\ {z}_{3}\end{matrix} ⌋ = {R}_{1} {R}_{2} {A}_{3} \qquad ( formula 15 )$$

Similarly, since the coordinate system changes with the change of the object, the measurement values being measured at multiple sampling times (n) should be mapped to the same reference frame if the motion of the object is required to be depicted correctly. In the present embodiment, all the measurement values are transformed to the present coordinate system, e.g., the coordinates at the first time. Therefore, for mapping the measurement value over a longer period of time, more mapping processes are required before the measurement value can be transformed to the present reference frame. The measurement values measured at different times can therefore be compared under the same reference frame.

After ‘n’ times of sampling, ‘n’ measurement values have been generated from the first measurement (first measurement value A₁(x₁, y₁, z₁)) to n^{th} measurement (n^{th} measurement value Aₙ(xₙ, yₙ, zₙ)). Except for the first measurement value A₁(x₁, y₁, z₁), the rest of the measurement values should be mapped to a specified reference frame via mapping processes. For example, the n^{th} measurement value Aₙ(xₙ, yₙ, zₙ) measured in n^{th} coordinate system (Xₙ, Yₙ, Zₙ) requires ‘n−1’ times of mapping process to be transformed to the same reference frame (e.g., the first coordinate system (X₁, Y₁, Z₁)) with the first measurement value A₁(x₁, y₁, z₁).

Reference is made to FIG. 9, which is a schematic diagram depicting the coordinate transformation. Formula 16 relates to that ‘n−1’ times of mapping require ‘n−1’ transformation matrices (R₁, R₂, R₃, . . . and Rₙ₋₁).

$$⌊ \begin{matrix}{x}_{1} \\ {y}_{1} \\ {z}_{1}\end{matrix} ⌋ = {R}_{1} ⌊ \begin{matrix}{x}_{2} \\ {y}_{2} \\ {z}_{2}\end{matrix} ⌋ = {R}_{1} {R}_{2} ⌊ \begin{matrix}{x}_{3} \\ {y}_{3} \\ {z}_{3}\end{matrix} ⌋ = {R}_{1} {R}_{2} … {R}_{n - 1} ⌊ \begin{matrix}{x}_{n} \\ {y}_{n} \\ {z}_{n}\end{matrix} ⌋ = {R}_{1} {R}_{2} … {R}_{n - 1} {A}_{n} \qquad ( formula 16 )$$

A general formula such as formula 17 indicates a transformation matrix R_{array} that represents ‘n’ times of matrix transformations.

R_{array}=[R₁,R₂,R₃,R₄, . . . ,Rₙ] (formula 17)

The transformation matrix (R_{array}) is provided for transforming the measurement values including accelerations and angular velocities measured by the linear acceleration sensor. A certain number of mapping processes are required to obtain a final measurement value A_{mapped}, as indicated in formula 18, after a final mapping process.

A_{mapped}=[A₁,R₁A₂,R₁R₂A₃,R₁R₂R₃A₄, . . . ,R₁R₂R₃ . . . Rₙ₋₁Aₙ] (formula 18)

After that, referring to the process described in FIG. 4 or FIG. 5, a specific means, such as a low-pass filtering process or a statistical method, is used to process the measurement values under the same reference frame so as to obtain a specific value from the measurement values. The specific value can be a value to be required or excluded. A gravity value G indicated in formula 19 is a low-frequency data that is required to be excluded by a low-pass filtering process. Furthermore, in another aspect of the disclosure, an average calculation can be performed on the measurement values being processed with multiple mapping processes, and an average value is calculated. The average value is the constant, e.g., the gravity value G, to be excluded.

G=lowpass(A₁,R₁R₂,R₁R₂A₃,R₁R₂R₃A₄, . . . ,R₁R₂R₃ . . . Rₙ₋₁Aₙ) (formula 19)

In conclusion, according to the above embodiments of the linear acceleration sensor and its operating method, in the electronic device associated with the linear acceleration sensor, the gravity value should be filtered out from the measurement values when a user uses the electronic device to perform a gesture. Therefore, a moving track can be obtained from the measurement values by a mathematic calculation method so as to identify the motion signals with respect to the electronic device in a 3D space.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A linear acceleration sensor, comprising:
a micro-controller, used to process signals generated by electronic components of the linear acceleration sensor;
an accelerometer, electrically connected with the micro-controller, used to measure multiple acceleration values rendered by the linear acceleration sensor along axes for a continuous period of time, and store the acceleration values into a first buffer;
a gyroscope, electrically connected with the micro-controller, used to measure multiple angular velocities rendered by the linear acceleration sensor for the continuous period of time, and store the angular velocities into a second buffer;
wherein the micro-controller performs an operating method including:
retrieving the acceleration values from the accelerometer;
retrieving angular velocities from the gyroscope;
transforming the acceleration values and the angular velocities to a reference frame through a mapping process;
filtering out a gravity value from the mapped acceleration values and the angular velocities; and
obtaining motion signals from the acceleration values and the angular velocities.

2. The linear acceleration sensor according to claim 1, wherein the acceleration values and the angular velocities rendered for the continuous period of time form a plurality of measurement values that include a first measurement value obtained in a first coordinate system at a first time and a second measurement value obtained in a second coordinate system at a second time; wherein the second measurement value at the second coordinate system is mapped to the first coordinate system and the gravity value is filtered out from the first measurement value and the second measurement value at the first coordinate system.

3. The linear acceleration sensor according to claim 2, wherein a low-pass filter adopted in the step of filtering is used to filter out the gravity value that is low-frequency signals.

4. The linear acceleration sensor according to claim 1, wherein the first buffer of the accelerometer and the second buffer of the gyroscope are part of a memory of the linear acceleration sensor.

5. The linear acceleration sensor according to claim 4, wherein the acceleration values and the angular velocities rendered for the continuous period of time form a plurality of measurement values that include a first measurement value obtained in a first coordinate system at a first time and a second measurement value obtained in a second coordinate system at a second time; wherein the second measurement value at the second coordinate system is mapped to the first coordinate system and the gravity value is filtered out from the first measurement value and the second measurement value at the first coordinate system.

6. The linear acceleration sensor according to claim 1, wherein the step of mapping is to transform the acceleration values and the angular velocities to the same reference frame from their original coordinate system.

7. The linear acceleration sensor according to claim 6, wherein a low-pass filter adopted in the step of filtering is used to filter out the gravity value that is low-frequency signals.

8. The linear acceleration sensor according to claim 7, wherein, the acceleration values and the angular velocities rendered for the continuous period of time form a plurality of measurement values that include a first measurement value obtained in a first coordinate system at a first time and a second measurement value obtained in a second coordinate system at a second time; wherein the second measurement value at the second coordinate system is mapped to the first coordinate system and the gravity value is filtered out from the first measurement value and the second measurement value at the first coordinate system.

9. An operating method performed in a linear acceleration sensor comprising:
continuously measuring a plurality of measurement values responsive to statuses of the linear acceleration sensor, and storing the measurement value to a memory;
retrieving the measurement values from the memory, and transforming the measurement values to a reference frame through a mapping process;
filtering out a gravity value from the mapped measurement values; and
obtaining motions signals of the linear acceleration sensor from the measurement values.

10. The method according to claim 9, wherein, the acceleration values and the angular velocities rendered for the continuous period of time form a plurality of measurement values that include a first measurement value obtained in a first coordinate system at a first time and a second measurement value obtained in a second coordinate system at a second time; wherein the second measurement value at the second coordinate system is mapped to the first coordinate system and the gravity value is filtered out from the first measurement value and the second measurement value at the first coordinate system.

11. The method according to claim 10, wherein a low-pass filter adopted in the step of filtering is used to filter out the gravity value that is low-frequency signals.

12. The method according to claim 9, wherein the linear acceleration sensor includes an accelerometer that is used to measure axial acceleration values of the linear acceleration sensor for a continuous period of time, and a gyroscope that is used to measure angular velocities of the linear acceleration sensor for a continuous period of time, and the measurement values formed by the acceleration values and the angular velocities are stored to the memory.

13. The method according to claim 12, wherein the acceleration values and the angular velocities rendered for the continuous period of time form a plurality of measurement values that include a first measurement value obtained in a first coordinate system at a first time and a second measurement value obtained in a second coordinate system at a second time; wherein the second measurement value at the second coordinate system is mapped to the first coordinate system and the gravity value is filtered out from the first measurement value and the second measurement value at the first coordinate system.

14. The method according to claim 12, wherein the step of mapping is to transform the acceleration values and the angular velocities to the same reference frame from their original coordinate system.

15. The method according to claim 14, wherein a low-pass filter adopted in the step of filtering is used to filter out the gravity value that is low-frequency signals.

16. The method according to claim 15, wherein, the acceleration values and the angular velocities rendered for the continuous period of time form a plurality of measurement values that include a first measurement value obtained in a first coordinate system at a first time and a second measurement value obtained in a second coordinate system at a second time; wherein the second measurement value at the second coordinate system is mapped to the first coordinate system and the gravity value is filtered out from the first measurement value and the second measurement value at the first coordinate system.
